(19) United States
(12) Patent Application Publication
(10) Pub. No.: US 2026/0196949 A1
(43) Pub. Date: Jul. 9, 2026

(54) CONTROL APPARATUS FOR THREE-LEVEL INVERTER AND PROGRAM

(71) Applicant: DENSO CORPORATION, Kariya-city (JP)

(72) Inventors: Yosuke SUZUKI, Kariya-city (JP); Junichi FUKUTA, Kariya-city (JP)

(73) Assignee: DENSO CORPORATION, Kariya-city (JP)

(21) Appl. No.: 19/554,305

(22) Filed: Mar. 2, 2026

Related U.S. Application Data
(63) Continuation of application No. PCT/JP2024/026982, filed on Jul. 29, 2024.

(30) Foreign Application Priority Data
Aug. 28, 2023 (JP) 2023-138400

(51) Int. Cl. H02M 7/539; H02P 21/22; H02P 27/00

(52) U.S. Cl. CPC H02M 7/539; H02P 21/22; H02P 27/00

(57) ABSTRACT

A control apparatus is applicable to a system including a first power storage unit, a second power storage unit, a rotating electric machine including armature windings for three phases, and a three-level inverter including switches, and performs switching control of the switches. The control apparatus includes: a setting unit that sets a drive pattern composed of a combination of drive states of the switches and occurrence periods of the drive states, based on a command voltage for controlling a controlled variable of the rotating electric machine to a command value; and a control unit that performs the switching control based on the set drive pattern and occurrence periods of the drive states. The setting unit sets the drive pattern to include at least two of three differing zero-voltage drive states. The control unit adjusts the occurrence periods of the zero-voltage drive states in the drive pattern in the switching control.

### CROSS-REFERENCE TO RELATED APPLICATIONS

The present application is a continuation application of International Application No. PCT/JP2024/026982, filed on July 29, 2024, which claims priority to Japanese Patent Application No. 2023-138400, filed on August 28, 2023. The contents of these applications are incorporated herein by reference in their entirety.

### BACKGROUND

The present disclosure relates to a control apparatus for a three-level inverter and a program.

Conventionally, a three-level inverter that includes two capacitors connected in series, and a switch electrically connected to an armature winding of a rotating electrical machine and the capacitors is known.

### SUMMARY

One aspect of the present disclosure provides a control apparatus for a three-level inverter applicable to a system. The system includes a first power storage unit and a second power storage unit connected in series, a rotating electric machine including armature windings for three phases, and a three-level inverter including, in the respective phases, switches that electrically connect the armature winding to any of a positive electrode side of the first power storage unit, a neutral point between a negative electrode side of the first power storage unit and a positive electrode side of the second power storage unit, and a negative electrode side of the second power storage unit, and performing switching control of the switches. The control apparatus includes a setting unit and a control unit. The setting unit sets a drive pattern composed of a combination of drive states of the switches and occurrence periods of the drive states, based on a command voltage for controlling a controlled variable of the rotating electric machine to a command value. The control unit performs the switching control based on the set drive pattern and occurrence periods of the drive states. Three differing drive states in which the armature winding of the respective phases is electrically connected to the positive electrode side of the first power storage unit, the neutral point, or the negative electrode side of the second power storage unit are zero-voltage drive states. The setting unit sets the drive pattern to include at least two of the zero-voltage drive states. The control unit adjusts the occurrence periods of the zero-voltage drive states included in the drive pattern in the switching control.

### BRIEF DESCRIPTION OF THE DRAWINGS

In the accompanying drawings:

FIG. 1 is an overall configuration diagram illustrating a control system according to a first embodiment;

FIG. 2 is a functional block diagram illustrating a torque control process performed by a control apparatus;

FIG. 3 is a diagram illustrating a vector space;

FIG. 4 is a diagram illustrating a first sector;

FIG. 5 is a timing chart for explaining a process performed by an adjusting unit;

FIG. 6 is a timing chart for explaining the process performed by the adjusting unit;

FIG. 7 is a flowchart illustrating processing steps for control performed by the control apparatus;

FIG. 8 is a timing chart illustrating switching control in a comparative example;

FIG. 9 is a timing chart illustrating an example of switching control;

FIG. 10 is a diagram for explaining switching modes of U-phase switches;

FIG. 11 is a diagram for explaining switching modes of the U-phase switches;

FIG. 12 is a diagram for explaining switching modes of the U-phase switches;

FIG. 13 is a diagram for explaining switching modes of the U-phase switches;

FIG. 14 is a timing chart for explaining a process performed by an adjusting unit according to a second embodiment;

FIG. 15 is a flowchart illustrating processing steps for control performed by a control apparatus;

FIG. 16 is a diagram illustrating power loss occurring in U-phase switches; and

FIG. 17 is a flowchart illustrating processing steps for control performed by a control apparatus according to another embodiment.

### DESCRIPTION OF THE EMBODIMENTS

Conventionally, a three-level inverter that includes two capacitors connected in series, and a switch electrically connected to an armature winding of a rotating electrical machine and the capacitors is known (see JP H08-098540 A).

To suppress reduction in reliability of switches provided corresponding to respective phases, occurrence of a situation in which load is concentrated on a specific switch among the switches is preferably suppressed.

It is thus desired to provide a control apparatus for a three-level inverter capable of suppressing a situation in which load is concentrated on a specific switch, and a program.

An exemplary embodiment of the present disclosure provides a control apparatus for a three-level inverter applicable to a system including a first power storage unit and a second power storage unit connected in series, a rotating electric machine including armature windings for three phases, and a three-level inverter including, in the respective phases, switches that electrically connect the armature winding to any of a positive electrode side of the first power storage unit, a neutral point between a negative electrode side of the first power storage unit and a positive electrode side of the second power storage unit, and a negative electrode side of the second power storage unit, and performing switching control of the switches, in which the control apparatus includes: a setting unit that sets a drive pattern composed of a combination of drive states of the switches and occurrence periods of the drive states, based on a command voltage for controlling a controlled variable of the rotating electric machine to a command value; and a control unit that performs the switching control based on the set drive pattern and occurrence periods of the drive states. Three differing drive states in which the armature winding of the respective phases is electrically connected to the positive electrode side of the first power storage unit, the neutral point, or the negative electrode side of the second power storage unit are zero-voltage drive states. The setting unit sets the drive pattern to include at least two of the zero-voltage drive states. The control unit adjusts the occurrence periods of the zero-voltage drive states included in the drive pattern in the switching control.

The drive pattern composed of a combination of the drive states of the switches and the occurrence periods of the drive states are set based on the command voltage for controlling the controlled variable of the rotating electric machine to the command value. In addition, the switching control of the switches is performed based on the set drive pattern and occurrence periods of the drive states. In this case, load may be concentrated on a specific switch among the switches. In this regard, in the three-level inverter, three differing zero-voltage drive states can be outputted. In the zero-voltage drive states, current paths differ and switches in which conduction loss occur differ.

Therefore, in the exemplary embodiment, in the switching control of the switches, the occurrence periods of the zero-voltage drive states included in the drive pattern are adjusted. In this case, loss occurring in the switches can be controlled within a range for which the occurrence periods of the zero-voltage drive states can be adjusted. As a result, the switching control can be performed such as to prevent occurrence of loss from being concentrated on a specific switch among the switches. Consequently, occurrence of a situation in which load is concentrated on a specific switch can be suppressed.

The above-described object, other objects, characteristics, and advantages of the present disclosure will be further clarified through the detailed description herebelow, with reference to the accompanying drawings.

A plurality of embodiments will be described with reference to the drawings. According to the plurality of embodiments, functionally and/or structurally corresponding sections and/or associated sections may be given the same reference numbers or references numbers having differing digits in the hundreds place and higher. Descriptions according to other embodiments can be referenced for corresponding sections and/or associated sections.

### First embodiment

A first embodiment actualizing a control apparatus of the present disclosure will hereinafter be described with reference to the drawings. The control apparatus according to the present embodiment is mounted in an electric vehicle such as an electric vehicle or a hybrid vehicle.

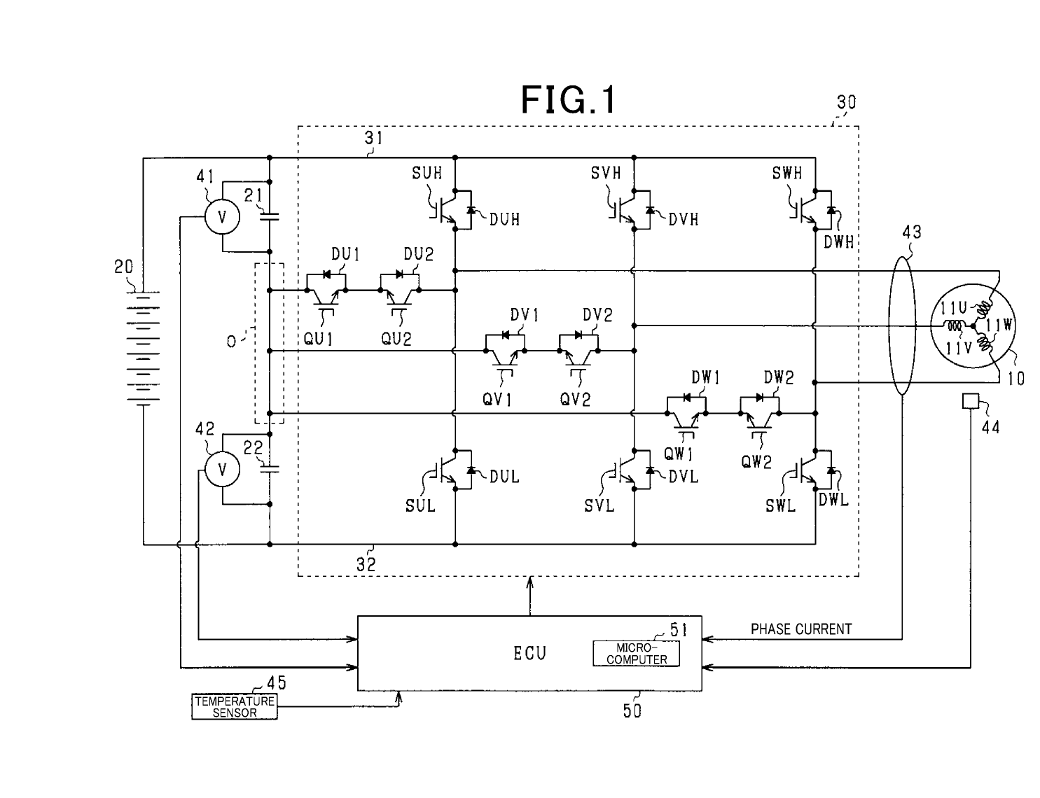

As shown in FIG. 1, an in-vehicle system includes a rotating electrical machine 10, a storage battery 20, and an inverter 30. The rotating electric machine 10 is a main onboard engine and capable of transmitting power to a drive wheel (not shown). The rotating electric machine 10 according to the present embodiment is a three-phase synchronous motor including a U-phase winding 11U, a V-phase winding 11V, and a W-phase winding 11W that are an armature winding. The phase windings 11U, 11V, and 11W are connected by a star connection. The phase windings 11U, 11V, and 11W are arranged such as to be shifted from each other by an electrical angle of 120°. For example, the rotating electric machine 10 may be a permanent-magnet synchronous motor.

The storage battery 20 is electrically connected to the rotating electrical machine 10 with the inverter 30 therebetween. For example, the storage battery 20 may be an assembled battery including a series connection body of battery cells. The storage battery 20 is a secondary battery capable of being charged and discharged, such as a lithium-ion storage battery or a nickel-metal hydride storage battery.

The inverter 30 is a power conversion circuit that converts direct-current power supplied from the storage battery 20 to three-phase alternating-current power through switching control, and supplies the converted alternating-current power to the rotating electric machine 10. On an input side of the inverter 30, the system includes a first capacitor 21 serving as a first power storage unit and a second capacitor 22 serving as a second power storage unit. The first capacitor 21 and the second capacitor 22 are connected in series. The storage battery 20 is connected in parallel to the series connection body of the first and second capacitors 21 and 22. According to the present embodiment, a capacitance of the first capacitor 21 and a capacitance of the second capacitor 22 are set to the same value. Here, the first capacitor 21 and the second capacitor 22 may be provided outside the inverter 30 or may be provided inside the inverter 30.

The inverter 30 is a T-type three-level inverter and includes series connection bodies composed of upper arm switches SUH, SVH, and SWH and lower arm switches SUL, SVL, and SWL for three phases. Each of the switches SUH to SWL is a voltage-controlled semiconductor switching element, and more specifically, an insulated-gate bipolar transistor (IGBT). In each of the switches SUH to SWL, a high-potential-side terminal is a collector and a low-potential-side terminal is an emitter. Freewheeling diodes DUH, DVH, DWH, DUL, DVL, and DWL are respectively connected in antiparallel to the switches SUH, SVH, SWH, SUL, SVL, and SWL.

The emitter of the U-phase upper arm switch SUH is connected to the collector of the U-phase lower arm switch SUL. A connection point between the U-phase upper arm switch SUH and the U-phase lower arm switch SUL is connected to a first end of U-phase winding 11U. The emitter of the V-phase upper arm switch SVH is connected to the collector of the V-phase lower arm switch SVL. A connection point between the V-phase upper arm switch SVH and the V-phase lower arm switch SVL is connected to a first end of V-phase winding 11V. The emitter of the W-phase upper arm switch SWH is connected to the collector of the W-phase lower arm switch SWL. A connection point between the W-phase upper arm switch SWH and the W-phase lower arm switch SWL is connected to a first end of W-phase winding 11W. Second ends of the phase windings 11U, 11V, and 11W are connected to one another at a motor neutral point.

The collectors of the upper arm switches SUH to SWH are connected by a positive-electrode-side bus 31 that is a conductive member such as a bus bar. The positive-electrode-side bus 31 is connected to a positive electrode terminal of the storage battery 20 and a first end of the first capacitor 21. A second end of the first capacitor 21 is connected to a first end of the second capacitor 22 with a capacitor neutral point O therebetween. The emitters of the lower arm switches SUL to SWL are connected to a negative-electrode-side bus 32 that is a conductive member such as a bus bar. The negative-electrode-side bus 32 is connected to a negative electrode terminal of the storage battery 20 and a second end of the second capacitor 22.

The inverter 30 includes middle switches QU1, QU2, QV1, QV2, QW1, and QW2 for three phases that conduct and interrupt currents bidirectionally. According to the present embodiment, each of the middle switches QU1, QU2, QV1, QV2, QW1, and QW2 is a voltage-controlled semiconductor switching element, and specifically an IGBT.

Specifically, when described with the U-phase as an example, the emitters of the U-phase first middle switch QU1 and the U-phase second middle switch QU2 are connected to each other. The collector of the U-phase second middle switch QU2 is connected to a connection point between the U-phase upper arm switch SUH and the U-phase lower arm switch SUL. The collector of the U-phase first middle switch QU1 is connected to the capacitor neutral point O.

In the respective phases, first diodes DU1, DV1, and DW1 serving as freewheeling diodes are respectively connected in antiparallel to the first middle switches QU1, QV1, and QW1. In the respective phases, second diodes DU2, DV2, and DW2 serving as freewheeling diodes are connected in antiparallel to the second middle switches QU2, QV2, and QW2.

A motor control system includes a first voltage sensor 41, a second voltage sensor 42, a phase current sensor 43, a rotation angle sensor 44 and a temperature sensor 45. The first voltage sensor 41 detects a terminal voltage of the first capacitor 21. The second voltage sensor 42 detects a terminal voltage of the second capacitor 22. The phase current sensor 43 detects U-, V-, and W-phase currents flowing to the phase windings 11U, 11V, and 11W. Here, the phase current sensor 43 is merely required to detect currents of at least two phases out of the three phases. The rotation angle sensor 44 may be, for example, a resolver, and detects the electrical angle of the rotating electrical machine 10. The temperature sensor 45 detects a temperature of the inverter 30. For example, the temperature sensor 45 may detect at least either of a temperature of cooling water that cools the inverter 30 and temperatures of the switches SUH to SWL and QU1 to QW2. The detected values of the sensors 41 to 45 are input to a control apparatus 50 provided in the system.

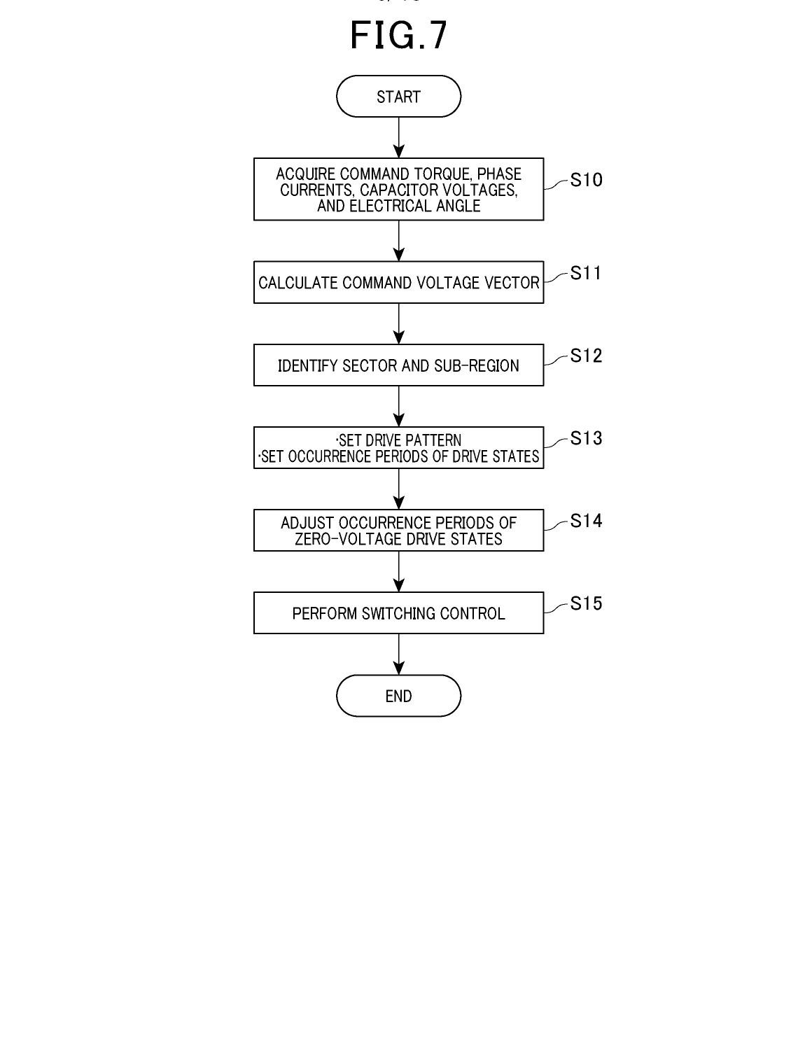

The control apparatus 50 is an electronic control apparatus (electronic control unit) mainly configured by a microcomputer 51. The microcomputer 51 includes a central processing unit (CPU). Functions provided by the microcomputer 51 can be provided by software recorded in a tangible memory device and a computer that executes the software, software alone, hardware alone, or a combination thereof. For example, when the microcomputer 51 is provided by an electronic circuit that is hardware, the microcomputer 51 can be provided by a digital circuit including numerous logic circuits or an analog circuit. For example, the microcomputer 51 may execute a program stored in a non-transitory, tangible storage medium that serves as a storage unit provided in the microcomputer 51 itself. For example, the program may include programs for processes shown in FIGS. 7, 15, 17, and the like, described hereafter. As a result of a set of instructions composing the program being performed, a method corresponding to the program is performed. For example, the storage unit may be a non-volatile memory. Here, the program stored in the storage unit can be updated over a communication network such as the Internet, through Over-The-Air (OTA), for example.

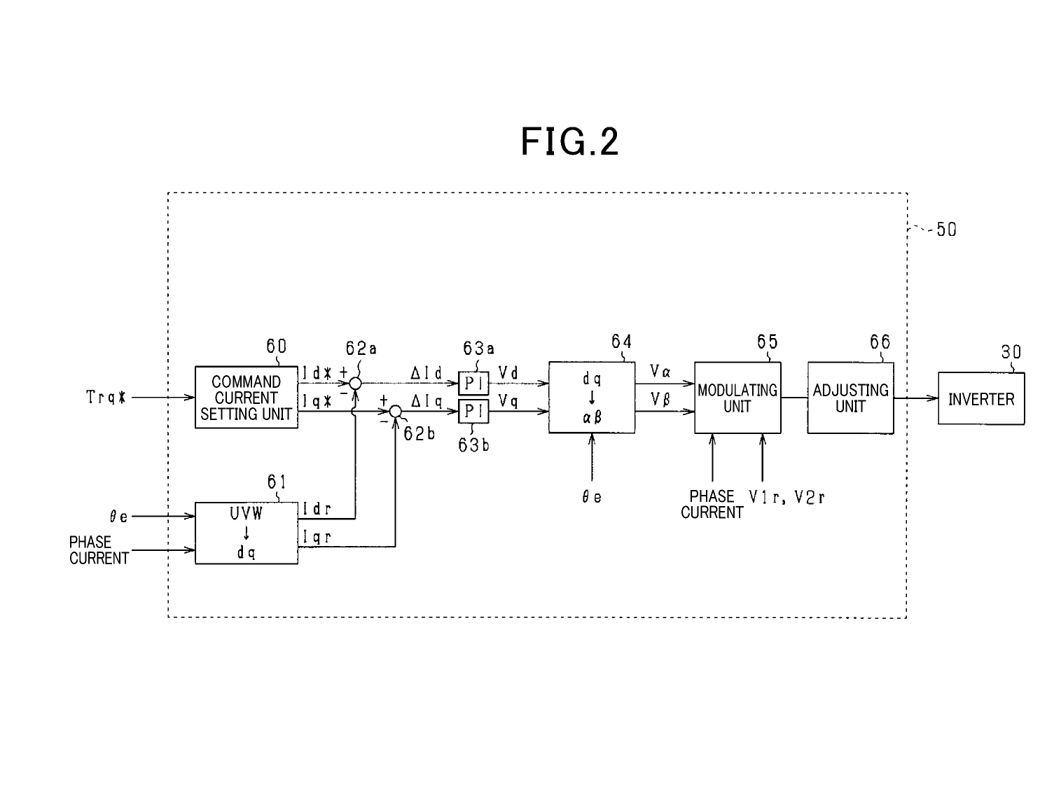

The control apparatus 50 performs switching control of the switches SUH to SWL and QU1 to QW2 of the inverter 30 that is control to control a controlled variable of the rotating electric machine 10 to a command value. The switching control by the control apparatus 50 will be described with reference to FIG. 2. In an example shown in FIG. 2, current feedback control is performed in the switching control. The controlled variable is a torque of the rotating electric machine 10, and the command value is a command torque Trq* input from a higher-order control apparatus.

In the control apparatus 50, a command current setting unit 60 sets d- and q-axis command currents Id* and Iq* based on the command torque Trq*. For example, the command current setting unit 60 may set the d- and q-axis command currents Id* and Iq* based on map information or mathematical expression information in which the command torque Trq* is associated with the d- and q-axis command currents Id* and Iq*.

A two-phase converting unit 61 converts the U-, V-, and W-phase currents in a three-phase fixed coordinate system to a d-axis current Idr and a q-axis current Iqr in a two-phase rotating coordinate system (dq coordinate system) based on detection values of the phase current sensor 43 and an electrical angle θe detected by the rotation angle sensor 44.

A d-axis deviation calculating unit 62a calculates a d-axis current deviation ΔId by subtracting the d-axis current Idr from the d-axis command current Id*. A q-axis deviation calculating unit 62b calculates a q-axis current deviation ΔIq by subtracting the q-axis current Iqr from the q-axis command current Iq*.

A d-axis command voltage calculating unit 63a calculates a d-axis command voltage Vd as a manipulated variable for feedback control of the d-axis current Idr to the d-axis command current Id* based on the d-axis current deviation ΔId. A q-axis command voltage calculating unit 63b calculates a q-axis command voltage Vq as a manipulated variable for feedback control of the q-axis current Iqr to the q-axis command current Iq* based on the q-axis current deviation ΔIq. Here, the feedback control used in the d-axis command voltage calculating unit 63a and the q-axis command voltage calculating unit 63b may be, for example, proportional-integral control.

A fixed coordinate converting unit 64 receives the d- and q-axis command voltages Vd and Vq output from the d- and q-axis command voltage calculating units 63a and 63b, and the electrical angle θe detected by the rotation angle sensor 44. The fixed coordinate converting unit 64 converts the d- and q-axis command voltages Vd and Vq in the two-phase rotating coordinate system to α- and β-axis command voltages Vα and Vβ in a two-phase fixed coordinate system based on the d- and q-axis command voltages Vd and Vq, and the electrical angle θe.

A modulating unit 65 calculates a command voltage vector Vαβ prescribed by the α- and β-axis command voltages Vα and Vβ. The command voltage vector Vαβ is a voltage vector for controlling the controlled variable of the rotating electric machine 10 to a command value.

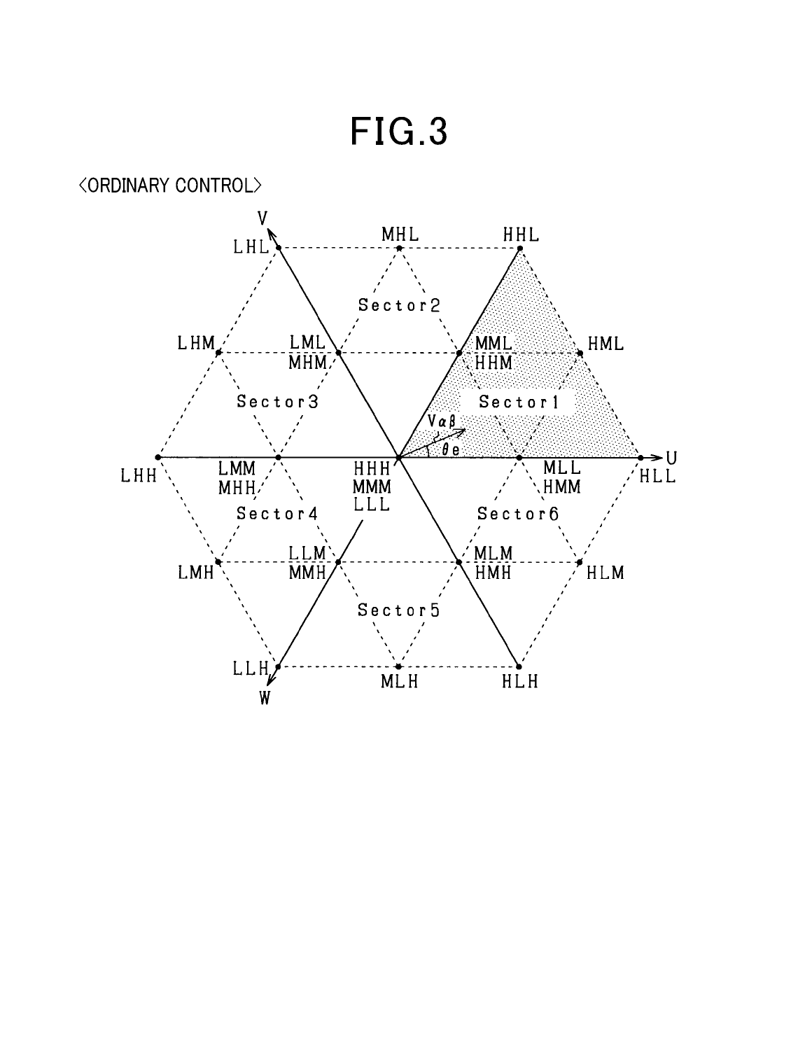

The modulating unit 65 identifies a sector in which a tip end of the command voltage vector Vαβ extending from a point of origin in a vector space is present. Sectors divide the vector space in which the command voltage vector Vαβ can be present into six sectors related to a deviation angle of the command voltage vector Vαβ. The deviation angle of the command voltage vector Vαβ is an angle formed by the command voltage vector Vαβ and a U-phase axis, and specifically, is the electrical angle θe. A sign of the electrical angle θe is positive for a leftward rotation (counterclockwise rotation). FIG. 3 shows first to sixth sectors that divide the vector space into six sectors. In the vector space, axes of the U, V, and W phases are arranged such as to be shifted from each other by an electrical angle of 120°. Each sector is an area sandwiched between two phase axes having an electrical angle difference of 60 degrees. In FIG. 3, an area indicating the first sector is stippled.

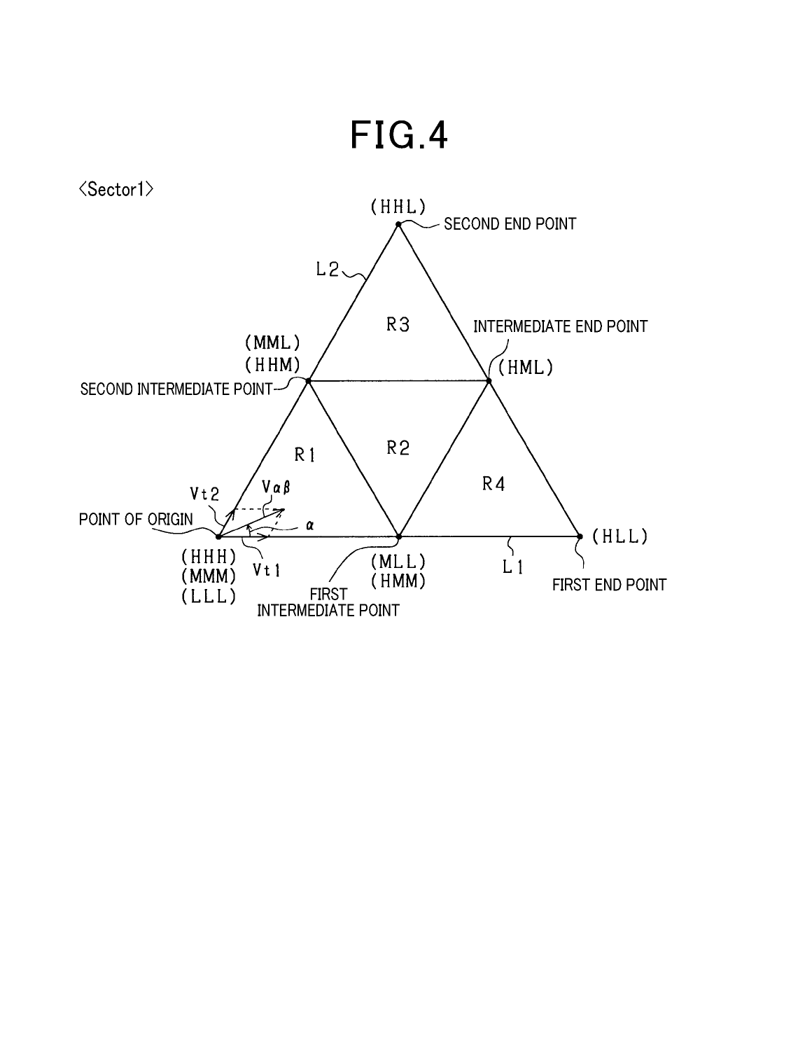

The first to sixth sectors are further divided into four regions. Specifically, an end point of the sector on a first axis L1 having a smaller deviation angle, of the axes of the two phases demarcating the sector, is referred to as a first end point, and an end point of the sector on a second axis L2 having a larger deviation angle is referred to as a second end point. In addition, an intermediate point between the point of origin and the first end point in the vector space is referred to as a first intermediate point, an intermediate point between the point of origin and the second end point is referred to as a second intermediate point, and an intermediate point between the first end point and the second end point is referred to as an intermediate end point. In this case, a first region R1 is a region surrounded by a triangle of which vertices are the point of origin, the first intermediate point, and the second intermediate point. A second region R2 is a region surrounded by a triangle of which the vertices are the first intermediate point, the second intermediate point, and the intermediate point. A third region R3 is a region surrounded by a triangle of which the vertices are the second end point, the second intermediate point, and the intermediate end point. A fourth region R4 is a region surrounded by a triangle of which the vertices are the first end point, the first intermediate point, and the intermediate end point. Here, in FIG. 4, the first to fourth regions R1 to R4 are shown using the first sector as an example.

Returning to the description of FIG. 2, above, for example, when 0° ≦ θe < 60°, the modulating unit 65 may determine that the tip end of the command voltage vector Vαβ is present in the first sector.

The modulating unit 65 identifies a sub-region that is a region in which the tip end of the command voltage vector Vαβ is present, among the first to fourth regions R1 to R4 configuring the identified sector, based on a magnitude of the command voltage vector Vαβ and an intra-sector angle α. The intra-sector angle α is an angle between the first axis L1 extending from the point of origin to the first end point and the command voltage vector Vαβ in a subject sector.

The modulating unit 65 selects a drive state of the switches SUH to SWL and QU1 to QW2 based on the identified sector and sub-region within the sector. As the drive state of the switches SUH to SWL and QU1 to QW2, a drive state corresponding to the three vertices forming the sub-region is selected.

As shown in FIG. 4, in the first sector, the first endpoint is HLL, the second endpoint is HHL, the first intermediate point is MLL and HMM, the second intermediate point is HHM and MML, and the intermediate end point is HML.

Symbols such as HML described above represent an output voltage level in the respective phases using three voltage levels H, M, and L, and correspond to the drive state of the switches SUH to SWL and QU1 to QW2.

A phase voltage at level H is output by the winding of a subject phase being electrically connected to the first end of the first capacitor 21. In this case, in the subject phase, the upper arm switch is turned on and the lower arm switch is turned off. In addition, in the subject phase, the first middle switch is turned on and the second middle switch is turned off. When the phase voltage at level H is output, the second middle switch in the subject phase is turned off to prevent short-circuiting between both ends of the first capacitor 21 through the upper arm switch, the second middle switch, and the first diode.

A phase voltage at level M is output by the winding of the subject phase being electrically connected to the capacitor neutral point O. In this case, in the subject phase, the first middle switch and the second middle switch are turned on, and the upper and lower arm switches are turned off.

A phase voltage at level L is output by the winding of the subject phase being electrically connected to the second end of the second capacitor 22. In this case, in the subject phase, the lower arm switch is turned on and the upper arm switch is turned off. In addition, in the subject phase, the second middle switch is turned on and the first middle switch is turned off. When the phase voltage at level L is output, the first middle switch in the subject phase is turned off to prevent short-circuiting between both ends of the second capacitor 22 through the lower arm switch, the first middle switch, and the second diode.

Here, when the voltage of the storage battery 20 is Vdc and the second end side of the second capacitor 22 has a reference potential (0 V), the phase voltage at level H is Vdc, the phase voltage at level M is Vdc / 2, and the phase voltage at level L is 0.

For example, HML may be a drive state of the switches SUH to SWL and QU1 to QW2 in which the U-phase voltage is at level H, the V-phase voltage is at level M, and the W-phase voltage is at level L. In the drive state HML, the U-phase upper arm switch SUH, the U-phase first middle switch QU1, the V-phase first middle switch QV1, the V-phase second middle switch QV2, the W-phase lower arm switch SWL, and the W-phase second middle switch QW2 are turned on, and the V- and W-phase upper arm switches SVH and SWH, the U-phase second middle switch QU2, the W-phase first middle switch QW1, and the U- and V-phase lower arm switches SUL and SVL are turned off.

HHH is a zero-voltage drive state of the switches SUH to SWL and QU1 to QW2 in which the output voltage levels of all three phases are set to H. In the zero-voltage drive state HHH, the upper arm switches SUH, SVH, and SWH of the respective phases and the first middle switches QU1, QV1, and QW1 of the respective phases are turned on, and the lower arm switches SUL, SVL, and SWL of the respective phases and the second middle switches QU2, QV2, and QW2 of the respective phases are turned off. In this case, the phase windings 11U, 11V, and 11W are electrically connected by the upper arm switches SUH, SVH, and SWH of the respective phases.

MMM is a zero-voltage drive state of the switches SUH to SWL and QU1 to QW2 in which the output voltage levels of all three phases are set to M. In the zero-voltage drive state MMM, the first middle switches QU1, QV1, and QW1 of the phases and the second middle switches QU2, QV2, and QW2 of the phases are turned on, and the upper arm switches SUH, SVH, and SWH of the phases and the lower arm switches SUL, SVL, and SWL of the phases are turned off. In this case, the phase windings 11U, 11V, and 11W are electrically connected by the first middle switches QU1, QV1, and QW1 of the phases and the second middle switches QU2, QV2, and QW2 of the phases.

LLL is a zero-voltage drive state of the switches SUH to SWL and QU1 to QW2 in which the output voltage levels of all three phases are set to L. In the zero-voltage drive state LLL, the lower arm switches SUL, SVL, and SWL of the phases and the second middle switches QU2, QV2, and QW2 of the phases are turned on, and the upper arm switches SUH, SVH, and SWH of the phases and the first middle switches QU1, QV1, and QW1 of the phases are turned off. In this case, the phase windings 11U, 11V, and 11W are electrically connected by the lower arm switches SUL, SVL, and SWL of the phases.

According to the present embodiment, among the drive states of the switches SUH to SWL and QU1 to QW2, the drive states other than the zero-voltage drive states HHH, MMM, and LLL are referred to as effective-voltage drive states.

MLL and HMM are at the same position in the vector space. In these two effective-voltage drive states, line voltages applied to the windings 11U to 11W are equivalent. In addition, this similarly applies to MML and HHM, LML and MHM, LMM and MHH, LLM and MMH, and MLM and HMH, in a similar manner as MLL and HMM. According to the present embodiment, MLL, MML, LML, LMM, LLM and MLM are referred to as Mid-Lo drive states, and HMM, HHM, MHM, MHH, MMH and HMH are referred to as Hi-Mid drive states.

In the switching control, a direction in which the voltage at the capacitor neutral point O changes is opposite between an occurrence period of the Mid-Lo drive state and an occurrence period of the Hi-Mid drive state. The modulating unit 65 acquires a detection voltage V1r of the first voltage sensor 41 and a detection voltage V2r of the second voltage sensor 42. In the switching control, the modulating unit 65 is able to select either the Mid-Lo drive state or the Hi-Mid drive state based on the acquired detection voltages V1r and V2r such that the voltage at the capacitor neutral point O falls within a predetermined range.

The modulating unit 65 sets a drive pattern composed of a combination of the drive states of the switches SUH to SWL and QU1 to QW2 based on the identified sector and sub-region within the sector. For example, when the command voltage vector Vαβ is identified as being present in the first region R1 of the first sector, the modulating unit 65 may set a drive pattern to drive the switches SUH to SWL and QU1 to QW2 in order of MMM → MML → MLL → LLL → MLL → MML → MMM, or set a drive pattern to drive the switches SUH to SWL and QU1 to QW2 in order of MMM → HMM → HHM → HHH → HHM → HMM → MMM.

When performing the switching control using the set drive pattern, the modulating unit 65 sets the occurrence period of the drive state of the switches SUH to SWL and QU1 to QW2.

Specifically, a case in which the command voltage vector Vαβ is present in the first region R1 of the first sector, as shown in FIG. 4, will be described. The modulator 65 decomposes the command voltage vector Vαβ into a first voltage vector Vt1 along the first axis L1 and a second voltage vector Vt2 along the second axis L2. The first voltage vector Vt1 is a vector obtained by a voltage vector corresponding to the first intermediate point being multiplied by ta (0 < ta < 1). The second voltage vector Vt2 is a vector obtained by a voltage vector corresponding to the second intermediate point being multiplied by tb (0 < tb < 1). The modulating unit 65 sets the occurrence period of the drive state corresponding to the first intermediate point to ta × TS and the occurrence period of the drive state corresponding to the second intermediate point to tb × TS in a single control cycle. Here, TS is a length of a single control cycle.

The modulating unit 65 sets a remaining period Tz (= TS – ta × TS – tb × TS) obtained by subtracting ta × TS and tb × TS from the length TS of a single control cycle as the occurrence period of the zero-voltage drive state. The remaining period Tz is a total period of the respective occurrence periods of the zero-voltage drive states HHH, MMM, and LLL in a single control cycle. Here, a period twice the length TS of a single control cycle corresponds to a single switching cycle Tsw of the switches SUH to SWL and QU1 to QW2.

For example, when a drive pattern including the drive states MML, MLL, MMM, and LLL is set, the modulating unit 65 may set the occurrence period of the drive state MLL to ta × TS and may set the occurrence period of the drive state MML to tb × TS. The modulating unit 65 also sets the occurrence period of the zero-voltage drive state LLL to TL and sets the occurrence period of the zero-voltage drive state MMM to TM. In this case, the total period TM + TL of the occurrence periods of the zero-voltage drive states MMM and LLL is the remaining period Tz.

In addition, for example, when a drive pattern including the drive states HMM, HHM, HHH, and MMM is set, the modulating unit 65 may set the occurrence period of the drive state HMM to ta × TS and may set the occurrence period of the drive state HHM to tb × TS. The modulating unit 65 also sets the occurrence period of the zero-voltage drive state HHH to TH and sets the occurrence period of the zero-voltage drive state MMM to TM. In this case, the total period TH + TM of the occurrence periods of the zero-voltage drive states HHH and MMM is the remaining period Tz.

As a result of the switching control being performed based on the drive pattern and the occurrence periods of the drive states set by the modulating unit 65, the torque of the rotating electric machine 10 is controlled to the command torque Trq*.

Incidentally, load being concentrated on a specific switch among the switches SUH to SWL and QU1 to QW2 during the switching control is a concern.

Specifically, during the switching control in the case in which the tip end of the command voltage vector Vαβ is present in the first region of the sector, the occurrence period TM of the zero-voltage drive state MMM may be longer than the occurrence periods TH and TL of the other zero-voltage drive states HHH and LLL. For example, in a state in which travel load is small, such as when a vehicle speed of the vehicle is low and the torque of the rotating electric machine 10 is low, the occurrence period TM of the zero-voltage drive state MMM tends to be longer than the occurrence periods TH and TL of the other zero-voltage drive states HHH and LLL. In this case, the load being concentrated on the middle switches QU1 to QW2 due to increase in conduction loss in the middle switches QU1 to QW2, among the switches SUH to SWL and QU1 to QW2, becomes a concern.

Here, the three-level inverter is capable of outputting three differing zero-voltage drive states HHH, MMM, and LLL. Current paths differ and switches in which conduction loss occurs differ among the zero-voltage drive states HHH, MMM, and LLL.

Therefore, the control apparatus 50 includes an adjusting unit 66. The adjusting unit 66 adjusts the occurrence periods of the zero-voltage drive states HHH, MMM, and LLL included in the drive pattern in the switching control of the switches SUH to SWL and QU1 to QW2. According to the present embodiment, the adjusting unit 66 adjusts the occurrence periods of the zero-voltage drive states HHH, MMM, and LLL such that the occurrence period of the zero-voltage drive state MMM included in the drive pattern is shorter than the occurrence period TM set by the modulating unit 65. Here, the zero-voltage drive state MMM corresponds to a “specific drive state”.

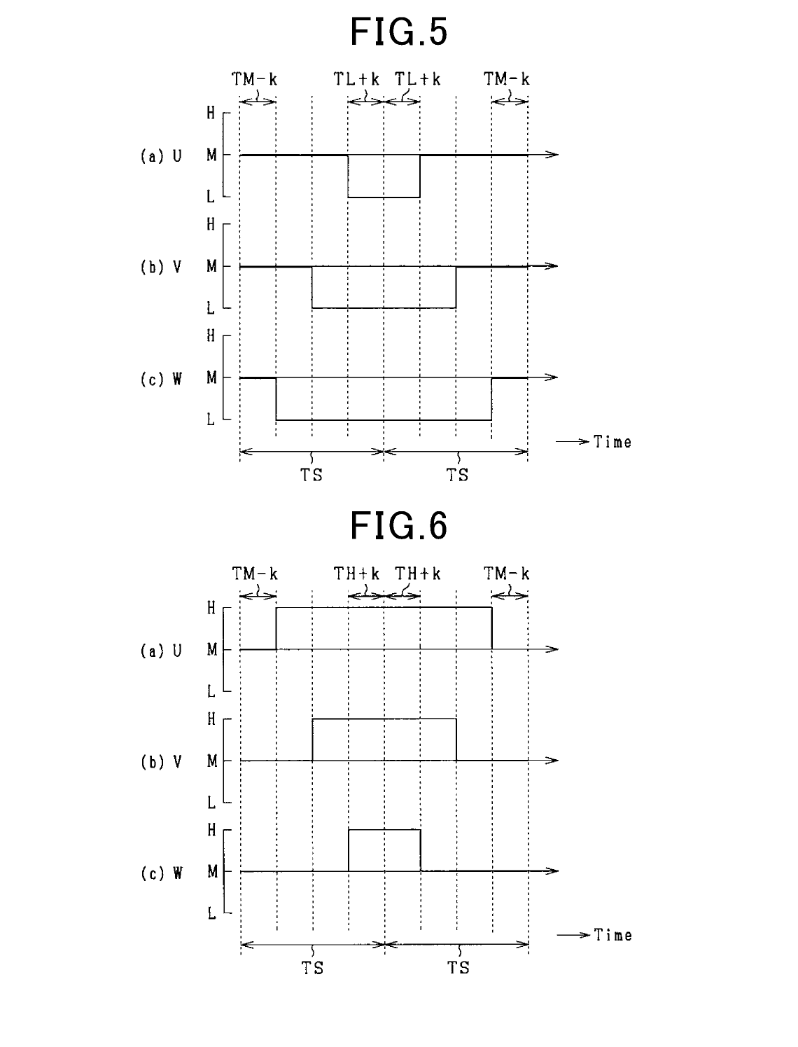

A process performed by the adjusting unit 66 will be described below with reference to FIG. 5 and FIG. 6. FIG. 5 and FIG. 6 show an example of transitions in phase voltages for two control cycles. In FIGS. 5 and 6, (a) shows the transition in the U-phase voltage level, (b) shows the transition in the V-phase voltage level, and (c) shows the transition in the W-phase voltage level.

In FIG. 5, the switches SUH to SWL and QU1 to QW2 are driven in order of MMM → MML → MLL → LLL → MLL → MML → MMM.

The adjusting unit 66 shortens the occurrence period of the zero-voltage drive state MMM by subtracting a predetermined adjustment period k from the occurrence period TM of the zero-voltage drive state MMM set by the modulating unit 65. The adjustment section 66 extends the occurrence period of the zero-voltage drive state LLL by adding the predetermined adjustment period k to the occurrence period TL of the zero-voltage drive state LLL set by the modulating unit 65. That is, the adjusting unit 66 adjusts the occurrence period of the zero-voltage drive state MMM to TM - k and adjusts the occurrence period of the zero-voltage drive state LLL to TL + k in a single control cycle. As a result, the occurrence period of the zero-voltage drive state MMM can be shortened without the total period (that is, the remaining period Tz) of the occurrence periods of the zero-voltage drive states MMM and LLL in a single control cycle being changed.

In FIG. 6, the switches SUH to SWL and QU1 to QW2 are driven in order of MMM → HMM → HHM → HHH → HHM → HMM → MMM.

The adjusting unit 66 shortens the occurrence period of the zero-voltage drive state MMM by subtracting the predetermined adjustment period k from the occurrence period TM of the zero-voltage drive state MMM set by the modulating unit 65. The adjustment section 66 extends the occurrence period of the zero-voltage drive state HHH by adding the predetermined adjustment period k to the occurrence period TH of the zero-voltage drive state HHH set by the modulating unit 65. That is, the adjusting unit 66 adjusts the occurrence period of the zero-voltage drive state MMM to TM - k and adjusts the occurrence period of the zero-voltage drive state HH to TL + k in a single control cycle. As a result, the occurrence period of the zero-voltage drive state MMM can be shortened without the total period (that is, the remaining period Tz) of the occurrence periods of the zero-voltage drive states HHH and MMM in a single control cycle being changed.

FIG. 7 shows processing steps for control performed by the control apparatus 50. This control is repeatedly performed at a predetermined cycle.

At step S10, the command torque Trq* input from the higher-order control apparatus, the phase currents flowing to the phase windings 11U to 11W, the voltages of the first and second capacitors 21, 22, and the electrical angle θe of the rotating electric machine 10 are acquired. The detection values of the phase current sensor 43 can be used as the phase currents. The detection voltage V1r of the first voltage sensor 41 can be used as the voltage of the first capacitor 21, and the detection voltage V2r of the second voltage sensor 42 can be used as the voltage of the second capacitor 22. The detection value of the rotation angle sensor 44 can be used as the electrical angle θe of the rotating electric machine 10.

At step S11, the command voltage vector Vαβ is calculated based on the acquired command torque Trq*, phase currents, and electrical angle θe. At step S12, the sector and the sub-region within the sector in which the command voltage vector Vαβ is present are identified. At steps S11 and S12, the control apparatus 50 functions as the command current setting unit 60, the two-phase converting unit 61, the deviation calculating units 62a and 62b, the command voltage calculating units 63a and 63b, the fixed coordinate converting unit 64, and the modulating unit 65, described above with reference FIG. 2.

At step S13, the drive pattern composed of a combination of the drive states of the switches SUH to SWL and QU1 to QW2 is set based on the identified sector and sub-region within that sector, and the acquired detection voltages V1r and V2r. Here, the drive pattern for two control cycles is set to include two differing zero-voltage drive states. In this case, the drive pattern is set to include the zero-voltage drive state MMM, and at least either of the remaining zero-voltage drive states HHH and LLL. Then, the occurrence period of each drive state included in the set drive pattern is set. In this case, the occurrence period of each effective-voltage drive state in a single control cycle is set based on the length of the voltage vector obtained by the command voltage vector Vαβ being decomposed. The remaining period Tz obtained by the occurrence period of each effective-voltage drive state being subtracted from the length TS of a single control cycle is set as the total period of the occurrence periods TH, TM, and TL of the zero-voltage drive states HHH, MMM, and LLL. Here, the process at step S13 corresponds to a “setting unit”.

At step S14, the occurrence period of the zero-voltage drive state included in the drive pattern is adjusted. According to the present embodiment, the occurrence period of the zero-voltage drive state included in the drive pattern is adjusted such that the occurrence period of the zero-voltage drive state MMM included in a single control cycle is shorter than that set in the process at step S13.

For example, when the command voltage vector Vαβ is present in the first region R1 of the sector, a drive pattern including the Mid-Lo drive state and the zero-voltage drive states MMM and LLL may be set. Then, the occurrence period of the zero-voltage drive state MMM in a single control cycle is set to TM, and occurrence period of the zero-voltage drive state LLL is set to TL. In this case, the occurrence periods of the zero-voltage drive states MMM and LLL are adjusted such that the occurrence period of the zero-voltage drive state MMM is TM - k and the occurrence period of the zero-voltage drive state LLL is TL + k.

In addition, for example, when the command voltage vector Vαβ is present in the first region R1 of the sector, a drive pattern including the Hi-Mid drive state and the zero-voltage drive states HHH and MMM may be set. Then, the occurrence period of the zero-voltage drive state MMM in a single control cycle is set to TM, and occurrence period of the zero-voltage drive state HHH is set to TH. In this case, the occurrence periods of the zero-voltage drive states HHH and MMM are adjusted such that the occurrence period TM of the zero-voltage drive state MMM is TM - k and the occurrence period TH of the zero-voltage drive state HHH is TH + k. Here, a period prescribed in advance can be used as the adjustment period k.

Here, when the command voltage vector Vαβ is identified as being present in the second to fourth regions R2 to R4 of the sector, the process at step S14 need not be performed.

At step S15, the switching control is performed based on the drive pattern of the switches SUH to SWL and QU1 to QW2 and the occurrence periods of the drive states set at steps S10 to S14. Here, the processes at steps S14 and S15 correspond to a “control unit”.

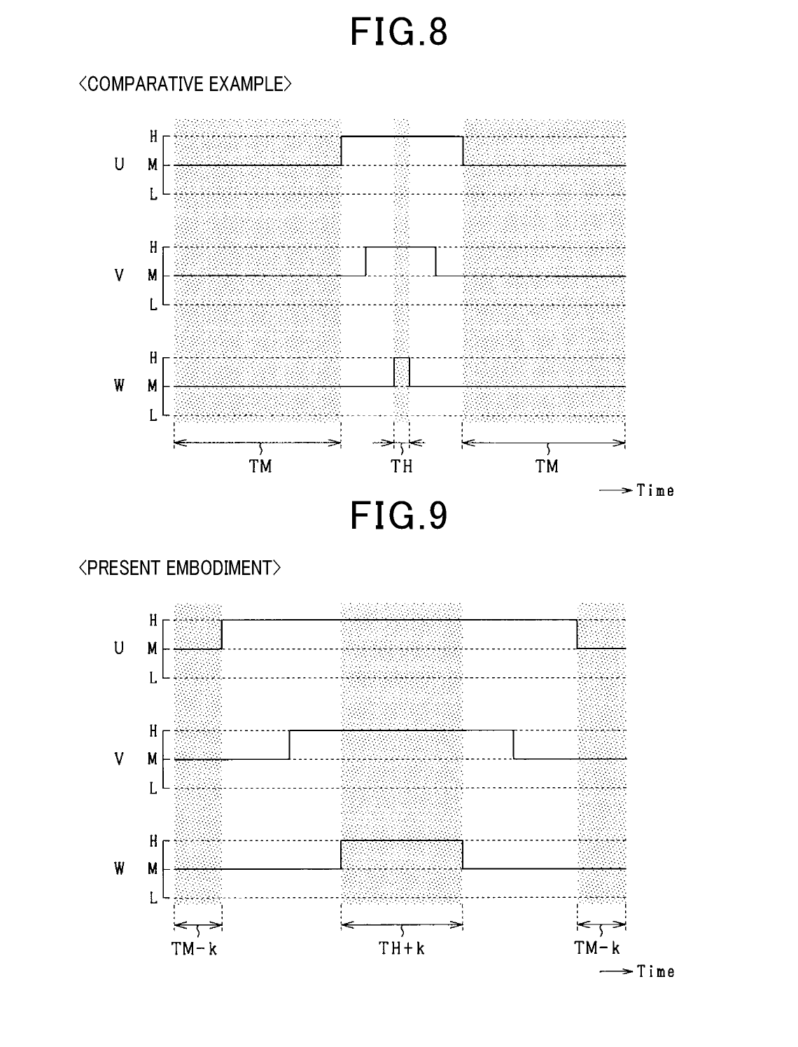

Next, working effects will be described with reference to FIG. 8 and FIG. 9. FIG. 8 is a comparative example in which the process at step S14 is not performed in the switching control of the switches SUH to SWL and QU1 to QW2. FIG. 9 is an example of the switching control of the switches SUH to SWL and QU1 to QW2 according to the present embodiment. FIG. 8 and FIG. 9 show transitions in the phase voltages.

In the comparative example in FIG. 8, conduction loss in the middle switches QU1 to QW2 may increase due to the occurrence period TM of the zero-voltage drive state MMM being long. In this case, load being concentrated on the middle switches QU1 to QW2 is a concern.

Therefore, according to the present embodiment, in the switching control of the switches SUH to SWL and QU1 to QW2, the occurrence periods of the zero-voltage drive states HHH, MMM, and LLL included in the drive pattern are adjusted. In this case, the conduction loss occurring in the switches SUH to SWL and QU1 to QW2 can be controlled within a range for which the occurrence periods of the zero-voltage drive states HHH, MMM, and LLL can be adjusted. Therefore, occurrence of a situation in which load is concentrated on the middle switches QU1 to QW2 can be suppressed.

In the control example in FIG. 9, the occurrence periods of the zero-voltage drive states HHH and MMM are adjusted such that the occurrence period of the zero-voltage drive state MMM is shortened by the adjustment period k compared to the occurrence period TM in the comparative example. In this case, the conduction loss in the middle switches QU1 to QW2 is reduced compared to that in the comparative example. As a result, loss occurring in the middle switches QU1 to QW2 in a concentrated manner can be prevented, and the occurrence of a situation in which load is concentrated on the middle switches QU1 to QW2 can be appropriately suppressed.

The occurrence period of the zero-voltage drive state HHH is extended to the extent that the occurrence period of the zero-voltage drive state MMM is shortened. As a result, the occurrence period of the zero-voltage drive state MMM can be shortened without the total period of the occurrence periods of the zero-voltage drive states HHH and MMM being changed.

### Second embodiment

A second embodiment will be described below with reference to the drawings, mainly focusing on differences from the first embodiment. According to the present embodiment, the adjusting unit 66 adjusts the occurrence periods of the zero-voltage drive states HHH, MMM, and LLL, taking into consideration difference in switching loss occurring during the switching control of the switches SUH to SWL and QU1 to QW2.

In the respective phases, in a state in which a current is flowing from the first end of the winding on the side connected to the switch of the inverter 30 to the second end of the winding on the motor neutral point side, switching modes of the upper arm switches SUH, SVH, and SWH and the first middle switches QU1, QV1, and QW1 are hard switching. In addition, switching modes of the lower arm switches SUL, SVL, and SWL and the second middle switches QU2, QV2, and QW2 are soft switching. In this case, the switching loss in the upper arm switches SUH, SVH, and SWH and the first middle switches QU1, QV1, and QW1 becomes greater than the switching loss in the lower arm switches SUL, SVL, and SWL and the second middle switches QU2, QV2, and QW2.

Meanwhile, in a state in which a current flows from the second end of the winding to the first end in the phases, the switching modes of the upper arm switches SUH, SVH, and SWH and the first middle switches QU1, QV1, and QW1 are soft switching. In addition, the switching modes of the lower arm switches SUL, SVL, and SWL and the second middle switches QU2, QV2, and QW2 are hard switching. In this case, the switching loss in the lower arm switches SUL, SVL, and SWL and the second middle switches QU2, QV2, and QW2 become greater than the switching loss in the upper arm switches SUH, SVH, and SWH and the first middle switches QU1, QV1, and QW1.

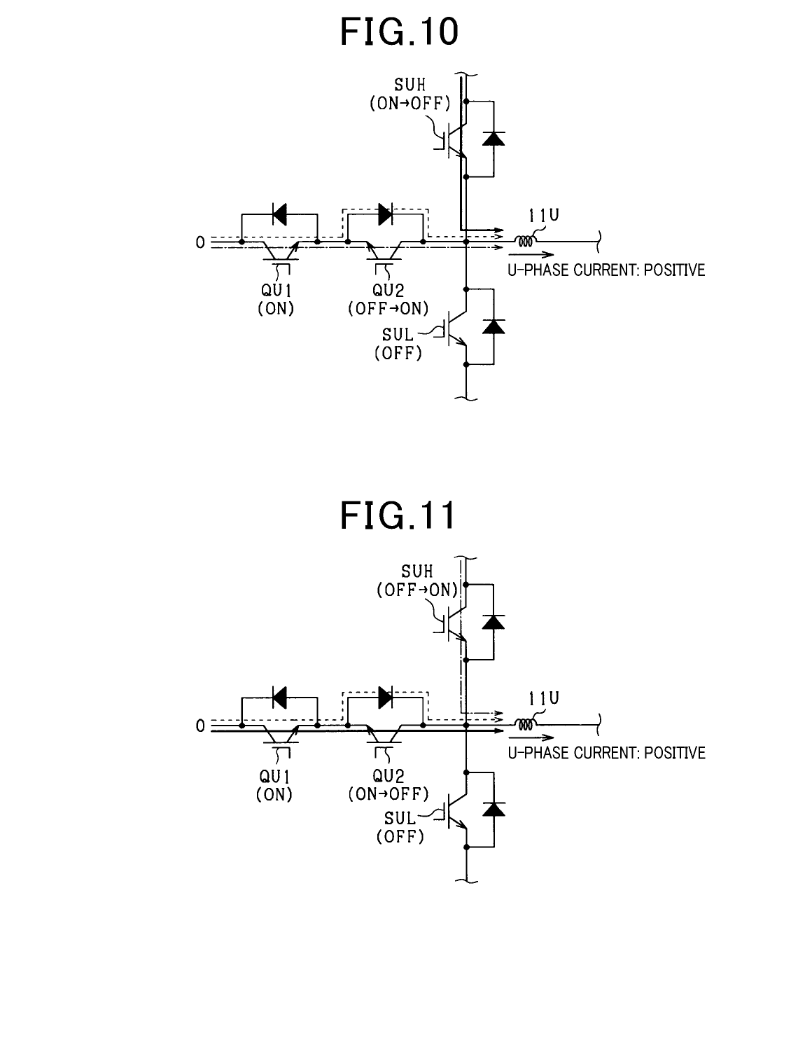

Here, using a state in which a current flows from the first end of the U-phase winding 11U to the second end as an example while referencing FIG. 10 to FIG. 13, the switching modes of the switches SUH and QU1 being hard switching and the switching modes of the switches SUL and QU2 being soft switching will be described. In FIG. 10 to FIG. 13, a solid line indicates a current path before dead time, a broken line indicates a current path during dead time, and a single-dot chain line indicates a current path after dead time.

FIG. 10 shows the current path when the U-phase voltage changes from level H to level M. In this case, the current flows to the U-phase upper arm switch SUH before the dead time at which the U-phase upper arm switch SUH and the U-phase second middle switch QU2 are turned off. As a result, when the U-phase upper arm switch SUH is turned off and a collector-emitter voltage of U-phase upper arm switch SUH starts to rise, turn-off loss occurs. During the dead time, the U-phase second diode DU2 is conductive. As a result, the U-phase second middle switch QU2 is turned on in a state in which a collector-emitter voltage of the U-phase second middle switch QU2 is reduced to near zero. Therefore, the occurrence of turn-on loss in the U-phase second middle switch QU2 is suppressed.

FIG. 11 shows the current path when the U-phase voltage changes from level M to level H. In this case, the current flows to the U-phase second middle switch QU2 before the dead time at which the U-phase upper arm switch SUH and the U-phase second middle switch QU2 are turned off. During the dead time, the U-phase second diode DU2 is conductive. As a result, the U-phase second middle switch QU2 is turned off in a state in which the collector-emitter voltage of the U-phase second middle switch QU2 is reduced to near zero. Therefore, the occurrence of turn-off loss in the U-phase second middle switch QU2 is suppressed. During the dead time, the collector-emitter voltage in the off state is applied to the U-phase upper arm switch SUH. As a result, when the U-phase upper arm switch SUH is turned on and the current starts to flow to the U-phase upper arm switch SUH, turn-on loss occurs.

That is, in the state shown in FIG. 10 and FIG. 11, the switching mode of the U-phase upper arm switch SUH is hard switching, and the switching mode of the U-phase second middle switch QU2 is soft switching.

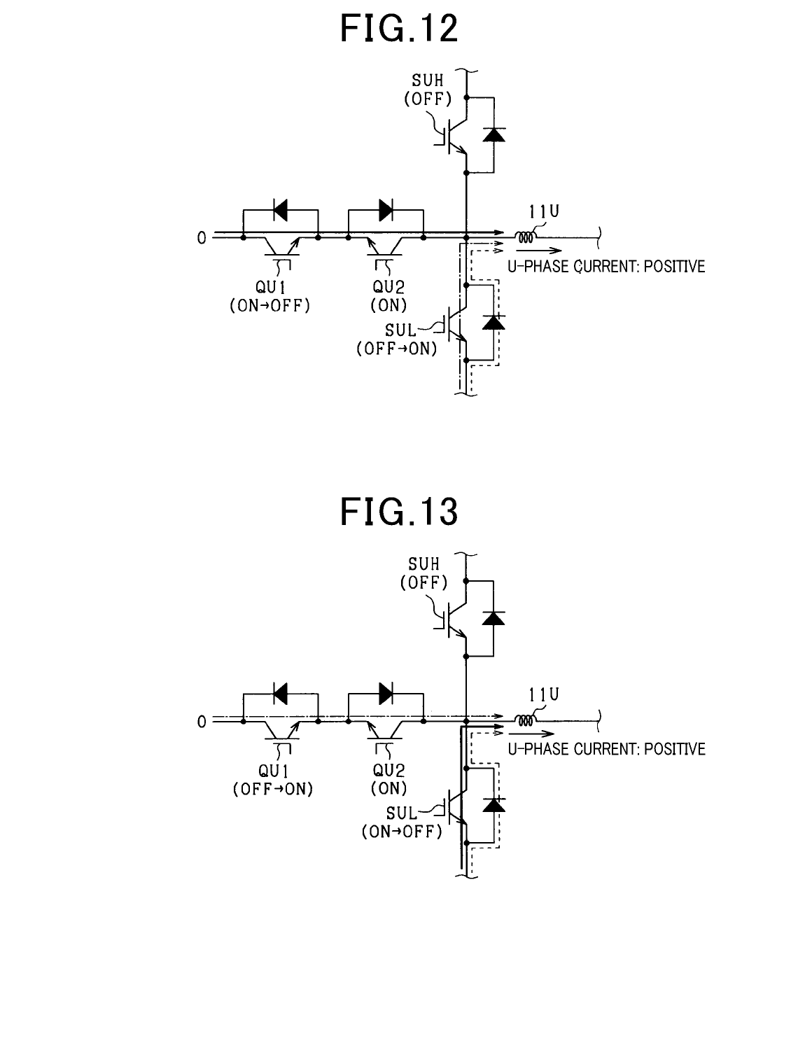

FIG. 12 shows the current path when the U-phase voltage changes from level M to level L. In this case, the current flows to the U-phase first middle switch QU1 before the dead time at which the U-phase first middle switch QU1 and the U-phase lower arm switch SUL are turned off. As a result, when the U-phase first middle switch QU1 is turned off and a collector-emitter voltage of U-phase first middle switch QU1 starts to rise, turn-off loss occurs. During the dead time, the U-phase lower arm diode DUL is conductive. As a result, the U-phase lower arm switch SUL is turned on in a state in which a collector-emitter voltage of U-phase lower arm switch SUL is reduced to near zero. Therefore, the occurrence of turn-on loss in the U-phase lower arm switch SUL is suppressed.

FIG. 13 shows the current path when the U-phase voltage changes from level L to level M. In this case, the current flows to the U-phase lower arm switch SUL before the dead time at which the U-phase first middle switch QU1 and the U-phase lower arm switch SUL are turned off. During the dead time, the U-phase lower arm diode DUL is conductive. As a result, the U-phase lower arm switch SUL is turned off in a state in which a collector-emitter voltage of U-phase lower arm switch SUL is reduced to near zero. Therefore, the occurrence of turn-off loss in the U-phase lower arm switch SUL is suppressed. During the dead time, the collector-emitter voltage in the off state is applied to the U-phase first middle switch QU1. As a result, when the U-phase first middle switch QU1 is turned on and the current starts to flow to the U-phase first middle switch QU1, turn-on loss occurs.

That is, in the state shown in FIG. 12 and FIG. 13, the switching mode of the U-phase first middle switch QU1 is hard switching, and the switching mode of the U-phase lower arm switch SUL is soft switching.

As described above, in the phases, depending on the direction of the current flowing through the winding, either of the upper arm switch and the first middle switch, and the lower arm switch and the second middle switch is in hard switching mode, and the other is in soft switching mode. In this case, in the switches in the soft switching mode among the upper arm switches SUH, SVH, and SWH of the phases and the lower arm switches SUL, SVL, and SWL of the phases, there is thought to be leeway to extend the occurrence period of the zero-voltage drive state, compared to the switches in the hard switching mode.

Therefore, according to the present embodiment, the adjusting unit 66 adjusts the occurrence periods of the zero-voltage drive states HHH, MMM, and LLL by causing a first adjustment period k1 for the zero-voltage drive state HHH serving as a “first drive state” and a second adjustment period k2 for the zero-voltage drive state LLL serving as a “second drive state” to differ from each other.

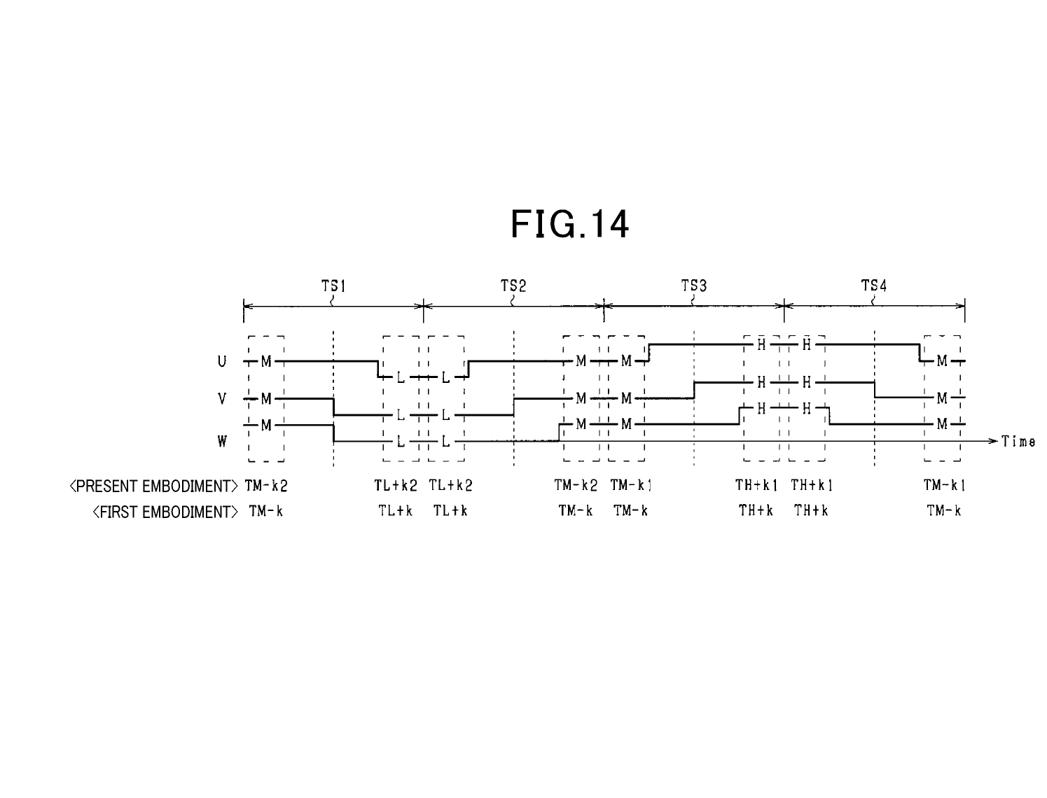

A process performed by the adjusting unit will be described in detail with reference to FIG. 14. FIG. 14 shows a drive pattern for four control cycles. The occurrence periods of the zero-voltage drive states HHH, MMM, and LLL are indicated by being surrounded by broken lines. Below the periods in the zero-voltage drive states HHH, MMM, and LLL, comparisons between the occurrence period after adjustment according to the present embodiment and the occurrence period after adjustment according to the first embodiment are shown.

In a first control cycle TS1 and a second control cycle TS2, a drive pattern including the Mid-Lo drive state and the zero-voltage drive states MMM and LLL is set. In this case, the adjusting unit 66 shortens the occurrence period TM of the zero-voltage drive state MMM set by the modulating unit 65 by the second adjustment period k2, and extends the occurrence period TL of the zero-voltage drive state LLL set by the modulating unit 65 by the second adjustment period k2.

In a third control cycle TS3 and a fourth control cycle TS4, a drive pattern including the Hi-Mid drive state and the zero-voltage drive states HHH and MMM is set. In this case, the adjusting unit 66 shortens the occurrence period TM of the zero-voltage drive state MMM set by the modulating unit 65 by the first adjustment period k1, and extends the occurrence period TH of the zero-voltage drive state HHH set by the modulating unit 65 by the first adjustment period k1.

That is, the adjusting unit 66 shortens the occurrence period of the zero-voltage drive state MMM by 2 × k1 + 2 × k2 and extends the total period of the occurrence periods of the other zero-voltage drive states HHH and LLL by 2 × k1 + 2 × k2 in the four control cycles.

The adjusting unit 66 determines a direction of each phase current. Here, in the respective phases, a direction in which the current flows from the first end of the winding to the second end is positive, and a direction in which current flows from the second end of the winding to the first end is negative. When determined that the direction of the phase current of a phase having a phase current of which the magnitude is the largest among the phases is positive, the adjusting unit 66 sets the second adjustment period k2 to a period longer than the first adjustment period k1. Meanwhile, when determined that the direction of the phase current of the phase having the phase current of which the magnitude is the largest is negative, the adjusting unit 66 sets the first adjustment period k1 to a period longer than the second adjustment period k2. As a result, the occurrence periods of the zero-voltage drive states HHH, MMM, and LLL are adjusted such that the first adjustment period k1 and the second adjustment period k2 differ from each other.

According to the present embodiment, in light of there being leeway to extend the occurrence period of the zero-voltage drive state in the switch of which the switching mode is the soft switching mode, the adjusting unit 66 is able to lengthen a shortening period of the occurrence period of the zero-voltage drive state MMM compared to that according to the first embodiment. That is, the adjusting unit 66 is able to adjust the occurrence periods of the zero-voltage drive states HHH, MMM, and LLL such that a total shortening period (corresponding to 2 × k1 + 2 × k2) of the occurrence period of the zero-voltage drive state MMM is longer than that (corresponding to 4 × k) according to the first embodiment in the four control cycles.

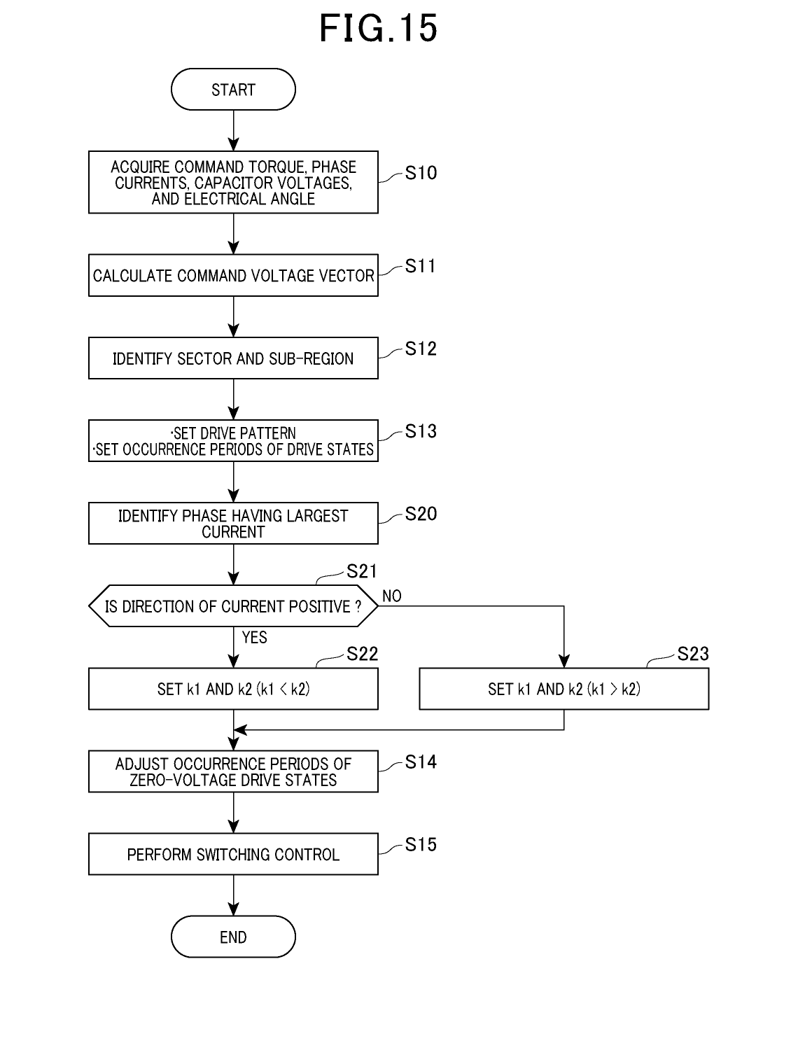

FIG. 15 shows processing steps for control performed by the control apparatus 50. This control is repeatedly performed at a predetermined cycle. Here, in FIG. 15, processes that are identical to the processes in FIG. 7 described above are given the same reference numbers for convenience.

At step S13, the drive pattern is set based on the identified sector and sub-region within the sector. Here, the drive pattern for four control periods is set to include the zero-voltage drive states HHH, MMM, and LLL. Then, the process proceed to step S20.

At step S20, the phase having the phase current of which the magnitude is the largest among the phases is identified based on the acquired phase currents. At step S21, whether the direction of the current flowing to the identified phase is positive is determined based on the acquired phase current. When an affirmative determination is made at step S21, the process proceeds to step S22. Meanwhile, when a negative determination is made at step S21, the process proceeds to step S23.

At step S22, the second adjustment period k2 is set to a period longer than the first adjustment period k1. The first and second adjustment periods k1 and k2 prescribed in advance such that the second adjustment period k2 is longer than the first adjustment period k1 can be used as the first and second adjustment periods k1 and k2.

At step S23, the first adjustment period k1 is set to a period longer than the second adjustment period k2. The first and second adjustment periods k1 and k2 prescribed in advance such that the first adjustment period k1 is longer than the second adjustment period k2 can be used as the first and second adjustment periods k1 and k2.

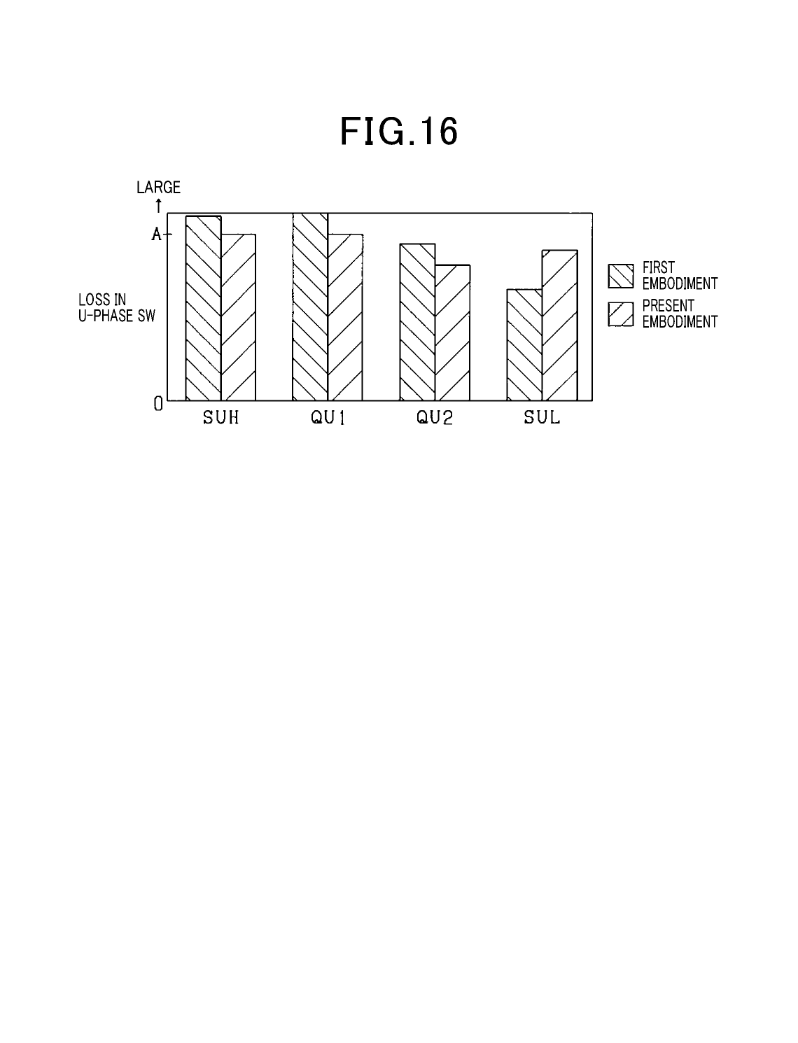

FIG. 16 shows a graph comparing the power loss that occurs when switching control is performed between the present embodiment (right bar graph) and the first embodiment (left bar graph). FIG. 16 compares the power losses occurring in the U-phase switches SUH, SUL, QU1, and QU2 in a state in which a current flows to the U-phase winding 11U, from the first end to the second end.

Conduction loss in the middle switches QU1 and QU2 is reduced by the occurrence period of the zero-voltage drive state MMM being shortened. Therefore, according to the first embodiment, the power loss in the U-phase first middle switch QU1 is reduced to become a level similar to that of the U-phase upper arm switch SUH.

In the state in which the current is flowing to the U-phase winding 11U from the first end to the second end, the switching mode of the U-phase lower arm switch SUL is soft switching. In this case, the power loss occurring in the U-phase lower arm switch SUL has a margin relative to a reference value A. The reference value A is a value used as a reference when considering a magnitude of power loss occurring when the switching control is performed. For example, the reference value A may be a value less than an allowable power loss.

According to the first embodiment, while the conduction loss in the middle switches QU1 and QU2 is reduced, and the occurrence of a situation in which load is concentrated on the middle switches QU1 and QU2 is suppressed, the loss occurring in the U-phase first middle switch QU1 is higher than the reference value A. In addition, the loss occurring in the U-phase upper arm switch SUH is higher than the reference value A.

Therefore, in FIG. 16, in light of there being a margin relative to the reference value A regarding the loss occurring in the U-phase lower arm switch SUL, the adjustment periods k1 and k2 are set such that the total shortening period of the zero-voltage drive state MMM is longer than that according to the first embodiment. In this case, the conduction loss in the U-phase first middle switch QU1 is reduced compared to that according to the first embodiment. As a result, the loss occurring in the U-phase first middle switch QU1 is kept within the reference value A.

According to the present embodiment, the adjustment periods k1 and k2 are set such that k1 < k2. In FIG. 16, the first adjustment period k1 is shorter than the adjustment period k according to the first embodiment. Therefore, the conduction loss in the U-phase upper arm switch SUH is reduced compared to that according to the first embodiment. As a result, the loss occurring in the U-phase upper arm switch SUH is kept within the reference value A. In addition, the second adjustment period k2 is extended beyond the adjustment period k according to the first embodiment, and the conduction loss in the U-phase lower arm switch SUL, while increased compared to that according to the first embodiment, is within the reference value A.

According to the present embodiment described in detail above, in addition to the occurrence period of the zero-voltage drive state MMM being shortened, extension periods of the occurrence periods of the remaining zero-voltage drive states HHH and LLL are adjusted. As a result, switching control suitable for dispersing conduction loss occurring in the switches SUH to SWL and QU1 to QW2 can be actualized.

In the switching control, the extension period of either of the zero-voltage drive states HHH and LLL is made shorter than the other based on the currents flowing to the phase windings 11U, 11V, and 11W. As a result, the extension periods of the zero-voltage drive states HHH and LLL can be appropriately prescribed, taking into consideration the differences in the switching loss occurring during the switching control of the switches SUH to SWL and QU1 to QW2. Therefore, switching control suitable for dispersing conduction loss occurring in the switches SUH to SWL and QU1 to QW2 can be actualized.

### Other embodiments

Here, the above-described embodiments may be as follows.

According to the first embodiment, instead of shortening the occurrence period of the zero-voltage drive state MMM, the adjusting unit 66 may adjust the occurrence periods of the zero-voltage drive states HHH, MMM, and LLL such as to shorten the occurrence periods of the other zero-voltage drive states HHH and LLL. That is, either of the zero-voltage drive states HHH and LLL may be set as the “specific drive state”. In this case, for example, at step S14 in FIG. 7 described above, the occurrence periods of the zero-voltage drive states MMM and LLL may be adjusted such that the occurrence period of the zero-voltage drive state MMM is TM + k and the occurrence period of the zero-voltage drive state LLL is TL - k. In addition, for example, the occurrence periods of the zero-voltage drive states HHH and MMM may be adjusted such that the occurrence period TM of the zero-voltage drive state MMM is TM + k and the occurrence period TH of the zero-voltage drive state HHH is TH - k.

According to the first embodiment, the adjusting unit 66 may select which of the occurrence periods of the zero-voltage drive states HHH, MMM, and LLL to shorten based on the temperatures of the switches SUH to SWL and QU1 to QW2. Specifically, at step S14 in FIG. 7 described above, a zero-voltage drive state in which the switch with the highest temperature among the upper arm switches SUH to SWH, the middle switches QU1 to QW2, and the lower arm switches SUL to SWL is turned on may be selected as the specific drive state. Then, the occurrence periods of the zero-voltage drive states HHH, MMM, and LLL may be adjusted such that the occurrence period of the selected specific drive state is shortened by the adjustment period k. The specific drive state can be selected using temperatures calculated based on the detection values of the temperature sensor 45.

According to the present embodiment, in the switching control, the occurrence period of the zero-voltage drive state in which the switch with the highest temperature among the upper arm switches SUH to SWH, the middle switches QU1 to QW2, and the lower arm switches SUL to SWL is turned on, is shortened. As a result, conduction loss occurring in the switch on which the load is concentrated can be appropriately reduced. Therefore, suitable switching control can be performed in terms of preventing occurrence of a situation in which load is concentrated on a specific switch among the switches SUH to SWL and QU1 to QW2.

According to the first embodiment and the second embodiment, the modulating unit 65 may adjust the occurrence periods of the zero-voltage drive states HHH, MMM, and LLL when setting the occurrence periods of the drive states of the switches SUH to SWL and QU1 to QW2. For example, the modulating unit 65 is able to set the occurrence period of each drive state included in the drive pattern using correspondence information (specifically, map information or mathematical expression information) associating the command voltage vector Vαβ with the occurrence periods of the drive states of the switches SUH to SWL and QU1 to QW2. In this case, as the correspondence information, information in which the occurrence periods of the zero-voltage drive states HHH, MMM, and LLL are adjusted, taking into consideration the conduction loss occurring in the switches SUH to SWL and QU1 to QW2 can be used.

According to the present embodiment, the control apparatus 50 may not include the adjusting unit 66. In addition, the process at step S14 in FIG. 7 described above may not be performed.

According to the first embodiment, the adjusting unit 66 is not limited to adjusting the occurrence periods of the zero-voltage drive states HHH, MMM, and LLL using the predetermined adjustment periods k, and may variably set the adjustment period k. For example, the adjusting unit 66 may set the adjustment period k to be long when the magnitude of the phase current is large compared to when the magnitude of the phase current is small, in the phase having the phase current of which the magnitude is the largest among the phases. The adjusting unit 66 can use the detection values of the phase current sensors 43 as the phase currents.

In addition, for example, the adjusting unit 66 may set the adjustment period k to be long when the temperatures of the switches SUH to SWL and QU1 to QW2 are high, compared to when the temperatures of the switches SUH to SWL and QU1 to QW2 are low. The adjusting unit 66 can use the detection values of the temperature sensor 45 as the temperatures of the switches SUH to SWL and QU1 to QW2. According to the second embodiment, the adjustment periods k1 and k2 can also be variably set based on at least either of the phase currents and the temperatures of the switches SUH to SWL and QU1 to QW2.

According to the present embodiment, the occurrence periods of the zero-voltage drive states HHH, MMM, and LLL can be appropriately adjusted based on the loads applied to the switches SUH to SWL and QU1 to QW2.

At step S14 in FIG. 7 described above, the adjustment period k can be set to the same length as the occurrence period TM set in the process at step S13. In this case, the occurrence period of the zero-voltage drive state MMM in a single control cycle is set to 0.

At step S14, when the occurrence period of the zero-voltage drive state MMM in a single control cycle is adjusted to 0, the drive pattern may be adjusted such that an effective-voltage drive state in which the phase voltage of at least one of the phases is at level M does not occur. For example, when the command voltage vector is present in the first sector, the drive pattern and the occurrence periods of the drive states may be adjusted such that the switching control is performed using the drive states HHL, HLL, HHH, and LLL.

At steps S22 and S23 in FIG. 15 described above, the total period of the adjustment periods k1 and k2 can be set to the same length as four times the occurrence period TM set by the process at step S13. In this case, the occurrence period of the zero-voltage drive state MMM for four control cycles is set to 0.

At steps S22 and S23, when the occurrence period of the zero-voltage drive state MMM for four control cycles is adjusted to 0, the drive pattern may be adjusted such that an effective-voltage drive state in which the phase voltage of at least one of the phases is at level M does not occur.

In the switching control of the switches SUH to SWL and QU1 to QW2, the occurrence period of the zero-voltage drive states HHH, MMM, and LLL may be adjusted when a predetermined execution condition is met.

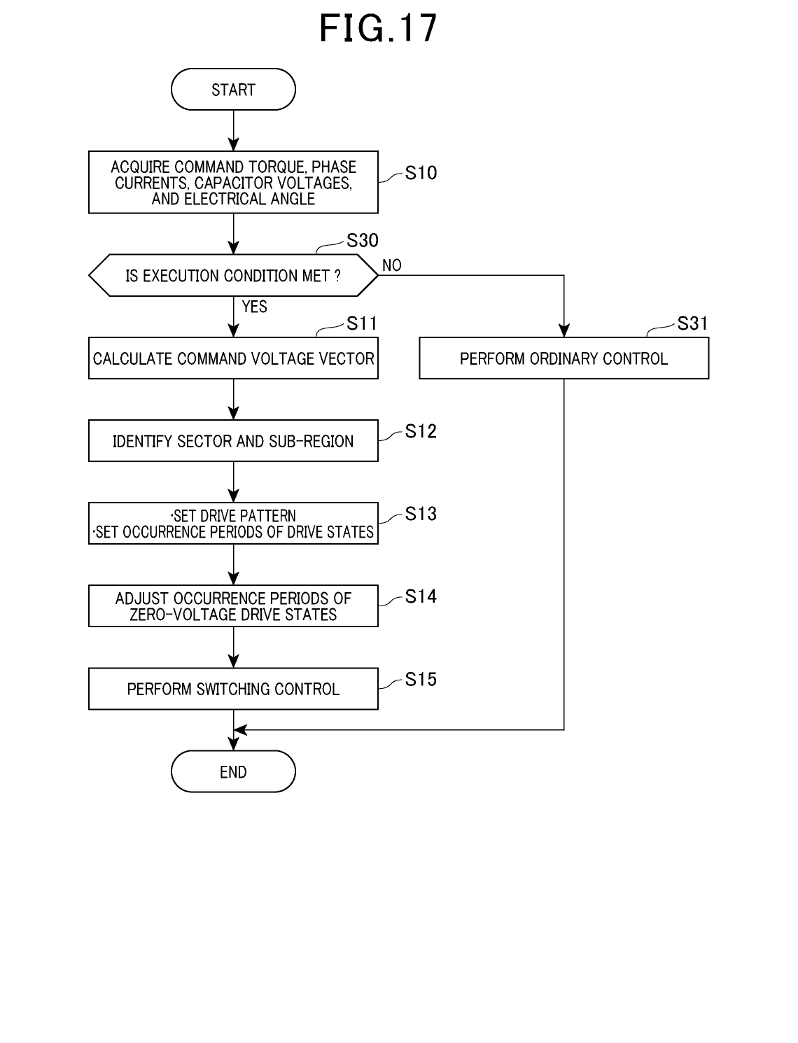

Specifically, the control apparatus 50 may perform control shown in FIG. 17 instead of the control shown in FIG. 7, described above. In this control, the process proceeds to step S30 after the process at step S10.

At step S30, whether a predetermined execution condition is met is determined. The execution condition is a condition enabling ascertainment of the inverter 30 being in an overheated state. For example, the execution condition may be a determination parameter value exceeding a threshold. The determination parameter value is a value calculated based on, for example, the command torque Trq*, a rotor rotation speed calculated based on the electrical angle θe, and the detection values of the temperature sensor 45.

When an affirmative determination is made at step S30, the process proceeds to step S11. Meanwhile, when a negative determination is made at step S30, the process proceeds to step S31. At step S31, ordinary control is performed. In ordinary control, the adjusting unit 66 performs the switching control without adjusting the occurrence periods of the zero-voltage drive states HHH, MMM, and LLL.

According to the second embodiment, the total shortening period of the occurrence period of the zero-voltage drive state MMM for four control cycles (corresponding to 2 × k1 + 2 × k2) need not be longer than that according to the first embodiment (corresponding to 4 × k). In this case as well, the extension periods of the occurrence periods of the zero-voltage drive states HHH and LLL can be adjusted.

The middle switches QU1 to QW2 of the phases may be configured such that respective collectors are connected to each other. Using the U-phase as an example, the collectors of the U-phase first middle switch QU1 and the U-phase second middle switch QU2 may be connected to each other. The emitter of the U-phase second middle switch QU2 may be connected to the connection point between the U-phase upper arm switch SUH and the U-phase lower arm switch SUL. The emitter of the U-phase first middle switch QU1 may be connected to the capacitor neutral point O. In this case, the U-phase first and second diodes DU1 and DU2 are arranged to be conductive in a direction opposite that according to the first embodiment.

In this configuration, the U-phase voltage is set to level H by the U-phase upper arm switch SUH and the U-phase second middle switch QU2 being turned on, and the U-phase lower arm switch SUL and the U-phase first middle switch QU1 being turned off. In addition, the U-phase voltage is set to level L by the U-phase lower arm switch SUL and the U-phase first middle switch QU1 being turned on, and the U-phase upper arm switch SUH and the U-phase second middle switch QU2 being turned off.

In this case, in the phases, in a state in which the current flows from the first end of the winding to the second end, the switching modes of the upper arm switches SUH, SVH, and SWH and the second middle switches QU2, QV2, and QW2 are hard switching. In addition, the switching modes of the lower arm switches SUL, SVL, SWL and the first middle switches QU1, QV1, QW1 are soft switching.

Furthermore, in the phases, in a state in which current flows from the second end of the winding to the first end, the switching modes of the upper arm switches SUH, SVH, SWH and the second middle switches QU2, QV2, QW2 are soft switching. In addition, the switching modes of the lower arm switches SUL, SVL, SWL and the first middle switches QU1, QV1, QW1 are hard switching.

A reverse blocking IGBT (RB-IGBT) may be used as the middle switch in the respective phases.

The semiconductor switches configuring the inverter are not limited to IGBTs, and may be, for example, N-channel metal-oxide field-effect transistors (MOSFETs). In this case, the high-potential-side terminal of the switch is a drain and the low-potential-side terminal is a source. In addition, each switch has a corresponding body diode.

The inverter is not limited to the inverter shown in FIG. 1, and may be another inverter such as a neutral-point clamp type.

The power storage unit connected to the inverter is not limited to a capacitor, and may be a chargeable and dischargeable storage battery.

The rotating electrical machine is not limited to that in which the windings of the phases are connected by star connection and may be that in which the windings are connected by Δ-connection.

The inverter, the rotating electric machine, and the control apparatus may be mounted on a moving body other than a vehicle, such as an aircraft or a ship. In the case in which the moving body is an aircraft, the rotating electric machine serves as a power source for flight of the aircraft. In the case in which the moving body is a ship, the rotating electric machine serves as a power source for navigation of the ship. In addition, the inverter, rotating electrical machine, and control apparatus are not limited to being mounted on a moving body.

A control unit and a method thereof described in the present disclosure may be actualized by a dedicated computer that is provided such as to be configured by a processor and a memory, the processor being programmed to provide one or a plurality of functions that are realized by a computer program. Alternatively, the control unit and a method thereof described in the present disclosure may be actualized by a dedicated computer that is provided by a processor being configured by a single dedicated hardware logic circuit or more. Still alternatively, the control unit and a method thereof described in the present disclosure may be actualized by a single dedicated computer or more. The dedicated computer may be configured by a combination of a processor that is programmed to provide one or a plurality of functions, a memory, and a processor that is configured by a single hardware logic circuit or more. In addition, the computer program may be stored in a non-transitory, tangible recording medium that can be read by a computer as instructions performed by the computer.

While the present disclosure has been described with reference to embodiments thereof, it is to be understood that the disclosure is not limited to the embodiments and constructions. The present disclosure is intended to cover various modification examples and modifications within the range of equivalency. In addition, various combinations and configurations, and further, other combinations and configurations including more, less, or only a single element thereof are also within the spirit and scope of the present disclosure.

What is claimed is:

1. A control apparatus for a three-level inverter,
the control apparatus being applicable to a system including
a first power storage unit and a second power storage unit connected in series,
a rotating electric machine including armature windings for three phases, and
a three-level inverter including, in the respective phases, switches that electrically connect the armature winding to any of a positive electrode side of the first power storage unit, a neutral point between a negative electrode side of the first power storage unit and a positive electrode side of the second power storage unit, and a negative electrode side of the second power storage unit, and performing switching control of the switches,
the control apparatus comprising:
a setting unit that sets a drive pattern composed of a combination of drive states of the switches and occurrence periods of the drive states, based on a command voltage for controlling a controlled variable of the rotating electric machine to a command value; and
a control unit that performs the switching control based on the set drive pattern and occurrence periods of the drive states, wherein
three differing drive states in which the armature winding of the respective phases is electrically connected to the positive electrode side of the first power storage unit, the neutral point, or the negative electrode side of the second power storage unit are zero-voltage drive states,
the setting unit sets the drive pattern to include at least two of the zero-voltage drive states, and
the control unit adjusts the occurrence periods of the zero-voltage drive states included in the drive pattern in the switching control.

2. The control apparatus for a three-level inverter according to claim 1, wherein:
the control unit adjusts the occurrence periods of the zero-voltage drive states such that an occurrence period of a specific drive state that is any of the zero-voltage drive states included in the drive pattern is shorter than that set by the setting unit, in the switching control.

3. The control apparatus for a three-level inverter according to claim 2, wherein:
the three-level inverter includes, as the switches,
an upper arm switch that electrically connects the armature winding to the positive electrode side of the first power storage unit, in the respective phases,
a middle switch that electrically connects the armature winding to the neutral point, in the respective phases, and
a lower arm switch that electrically connects the armature winding to the negative electrode side of the second power storage unit, in the respective phases, and
the specific drive state is the zero-voltage drive state in which the armature winding of the respective phases is electrically connected by the middle switch of the respective phases.

4. The control apparatus for a three-level inverter according to claim 3, wherein:
the setting unit sets the drive pattern to include three differing zero-voltage drive states, and
the control unit, in the switching control,
shortens the occurrence period of the specific drive state to be shorter than that set by the setting unit,
extends a total period of an occurrence period of a first drive state and an occurrence period of a second drive state by an amount amounting to the shortening of the occurrence period of the specific drive state, the first drive state being the zero-voltage drive state in which the armature winding of the respective phases is electrically connected by the upper arm switch of the respective phases, and the second drive state being the zero-voltage drive state in which the armature winding of the respective phases is electrically connected by the lower arm switch of the respective phases, and
adjusts the occurrence periods of the zero-voltage drive states such that an extension period of the occurrence period of the first drive state and an extension period of the occurrence period of the second drive state differ.

5. The control apparatus for a three-level inverter according to claim 4, wherein:
the control unit determines which of the extension period of the occurrence period of the first drive state and the extension period of the occurrence period of the second drive state is to be made shorter than the other, based on a current flowing to each armature winding, in the switching control.

6. The control apparatus for a three-level inverter according to claim 2, wherein:
the three-level inverter includes, as the switches,
an upper arm switch that electrically connects the armature winding to the positive electrode side of the first power storage unit, in the respective phases,
a middle switch that electrically connects the armature winding to the neutral point, in the respective phases, and
a lower arm switch that electrically connects the armature winding to the negative electrode side of the second power storage unit, in the respective phases, and
the control unit, in the switching control,
selects the zero-voltage drive state in which a switch having a highest temperature among the upper arm switch, the middle switch, and the lower arm switch is turned on as the specific drive state, and
adjusts the occurrence periods of the zero-voltage drive states such that the occurrence period of the selected specific drive state is shorter than that set by the setting unit.

7. A non-transitory computer-readable storage medium storing therein a program applicable to a system,
the system comprising
a first power storage unit and a second power storage unit connected in series,
a rotating electric machine including armature windings for three phases,
a three-level inverter including, in the respective phases, switches that electrically connect the armature winding to any of a positive electrode side of the first power storage unit, a neutral point between a negative electrode side of the first power storage unit and a positive electrode side of the second power storage unit, and a negative electrode side of the second power storage unit, and
a computer, the program causing the computer to implement switching control of the switches, wherein:
the program causes the computer to implement a process comprising:
a setting step of setting a drive pattern composed of a combination of drive states of the switches and occurrence periods of the drive states, based on a command voltage for controlling a controlled variable of the rotating electric machine to a command value; and
a control step of performing the switching control based on the set drive pattern and occurrence periods of the drive states;
three differing drive states in which the armature winding of the respective phases is electrically connected to the positive electrode side of the first power storage unit, the neutral point, or the negative electrode side of the second power storage unit are zero-voltage drive states;
the setting step comprises
setting the drive pattern to include at least two of the zero-voltage drive states; and
the control step comprises
adjusting the occurrence periods of the zero-voltage drive states included in the drive pattern in the switching control.
